(19) United States
(12) Patent Application Publication
(10) Pub. No.: US 2004/0189454 A1
(43) Pub. Date: Sep. 30, 2004

(54) Sensor device for detecting and transmitting vehicle motion data

(76) Inventor: Yasuki Shimoyama, Anjo-city (JP)

Correspondence Address: POSZ & BETHARDS, PLC, 11250 ROGER BACON DRIVE, SUITE 10, RESTON, VA, 20190, US

(21) Appl. No.: 10/779,619

(22) Filed: Feb. 18, 2004

(30) Foreign Application Priority Data
Mar. 25, 2003 (JP) 2003-82835

(51) Int. Cl. B60Q 1/00

(52) U.S. Cl. 340/436

(57) ABSTRACT

A sensor device is arranged in a compartment near the center of the vehicle, and transmits the motional data representing the motion of the vehicle obtained from sensors to other ECUs and devices connected to an in-vehicle LAN through a bus controller. The sensor device has a function of a drive recorder which stores the operation data (operating states of the accelerator pedal, steering wheel, brake pedal, etc.) together with the motional data in a memory. In case collision of the vehicle is detected by a collision G sensor, inhibits the writing into the memory after a standby period has passed, and holds the motional data and the operation data before and after the collision stored in the memory.

### CROSS REFERENCE TO RELATED APPLICATION

This application is based on and incorporates herein by reference Japanese Patent Application No. 2003-82835 filed on Mar. 25, 2003.

### FIELD OF THE INVENTION

This invention relates to a sensor device which detects the motion of a vehicle and transmits the detected results to various parts of the vehicle through a communication network (in-vehicle LAN) built up in the vehicle.

### BACKGROUND OF THE INVENTION

Conventionally a drive recorder records motional data representing motion (speed, shock) of a vehicle and operation data representing the operating states (steering and braking operations) of a passenger in case an vehicle is involved in a traffic accident or in case an action is taken such as applying emergency brake to avoid an accident.

The drive recorder is constructed as an exclusive electronic control unit (ECU) in JP-A-7-244064, or is incorporated in various ECUs connected to an in-vehicle LAN, such as an air bag ECU which uses a collision trigger signal in common, an ABS (anti-lock brake system) ECU which uses in common an acceleration signal in a direction in which the vehicle is traveling or, when there exists a plurality of in-vehicle LANs, in a gateway ECU that connects them in US 2002-161497 or JP-A-2002-330149.

When the drive recorder is constructed as an exclusive ECU, however, space must be newly provided for its installation, or the setting of the communication environment must be changed to cope with an increase in the ECUs connected to the in-vehicle LAN, requiring laborious work for the installation and greatly increasing the cost.

When the drive recorder is incorporated in the air bag ECU, ABS ECU or gateway ECU, important motional data must be partly or wholly input through the in-vehicle LAN. In case the ECU transmitting the data is destroyed or the signal lines of the in-vehicle LAN are broken due to collision, it is not possible to obtain part or whole of the motional data just before and just after the collision.

In recent years, in particular, the ABS ECU has been fabricated integrally with a brake ACT (actuator) being, generally, mounted in an engine compartment that is subject to be collapsed in case of collision. When the drive recorder is mounted on the ABS ECU, therefore, it is highly probable that the drive recorder itself is destroyed making it difficult to recover the data.

### SUMMARY OF THE INVENTION

It is an object of the present invention to provide a function of a drive recorder at a low cost, making it possible to reliably record the motion of a vehicle at the time of collision and to highly reliably recover the recorded data after the collision.

A sensor device of the present invention is provided separately from a plurality of electronic control units (ECUs) for controlling the vehicle, detects the motion of the vehicle, and transmits the detected results to other units connected to a communication network through the communication network built up in the vehicle. Further, the sensor device of the invention is capable of updating the stored content. When the power supply is interrupted, updates the stored content so as to hold the stored content of detected results for a period of time that has been set in advance. In case collision of the vehicle is detected from the acceleration exerting on the vehicle, the updating operation is not effected to hold the stored content.

That is, the sensor device for detecting the motion of the vehicle which is the most important data to be recorded by the drive recorder, is provided with functions as a drive recorder, i.e., a function for recording the detected results of motion of the vehicle and a function for detecting the occurrence of collision and for holding the recorded content.

It is therefore made possible to provide the function of the drive recorder at a low cost without installing any new exclusive device. Beside, the same device detects the motion of the vehicle and records the detected results. Therefore, even in case other devices and the communication network are destroyed due to collision, the motion of the vehicle at the time of collision or just before the collision can be reliably recorded provided the sensor device itself is not destroyed.

From the functional requirement, further, the sensor device for detecting the motion of the vehicle is generally mounted on nearly the central portion of the vehicle. Near the center of the vehicle is provided the compartment the structure of which is not easily crushed to protect the passengers. The sensor device that is mounted in this portion is less likely to be destroyed at the time of collision. After the collision, therefore, the data recorded in a storage device can be recovered highly reliably.

The updating operation may be readily discontinued in case the collision is detected. For example, the updating operation may be discontinued after the passage of a standby period which is set to be shorter than the holding period. In this case, not only the data just before the collision but also the data just after the collision are recorded, from which a variety of information can be obtained.

The motion of the vehicle can be detected by at least any one of a longitudinal G sensor for detecting the acceleration exerted in a direction in which the vehicle is traveling, a lateral G sensor for detecting the acceleration exerted in a direction of width of the vehicle or a yaw rate sensor for detecting the acceleration exerted in a direction in which the vehicle turns. Desirably, however, the motion of the vehicle is detected by all of these sensors.

Here, the sensor device of the invention may be so constructed as to receive the operation data representing the operating state of the vehicle through the communication network built up in the vehicle, and to update the stored content so as to store the detected results of motion as well as the operation data that are received.

In this case, at least any one of the operating state of the accelerator pedal, operating state of the steering wheel or operating state of the brake pedal may be received as the operation data. It is, however, desired that all of these states are received.

The operation data are based on the operation by the passenger and the speed of response is limited due to a delay. However, though the data at the moment of collision cannot be obtained, the state at the moment of collision can be relatively easily estimated from the operation data at a moment of just before the collision. Namely, the operation data are different from the data related to the motion of the vehicle, and sufficiently helpful data can be obtained even when the data are obtained from other devices through the communication network.

The data to be recorded are not limited to those data (outputs of the longitudinal G sensor, lateral G sensor, yaw rate sensor) that represent the motion of the vehicle or the operation data (operating states of the accelerator pedal, steering wheel, brake pedal). The data may further include vehicle speed, vehicle position, throttle opening amount, external atmospheric temperature, cooling water temperature as well as various data obtained from other electronic control units (ECUs) through the in-vehicle LAN.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram schematically illustrating a sensor device and an in-vehicle LAN to which the sensor device is connected according to an embodiment;

FIG. 2 is a flowchart illustrating main processing executed by a microcomputer in the sensor device; and

FIG. 3 is a flowchart illustrating data transmission and reception/memory write processing executed together with the main processing by the microcomputer in the sensor device.

### DETAILED DESCRIPTION OF THE PREFERRED EMBODIMENTS

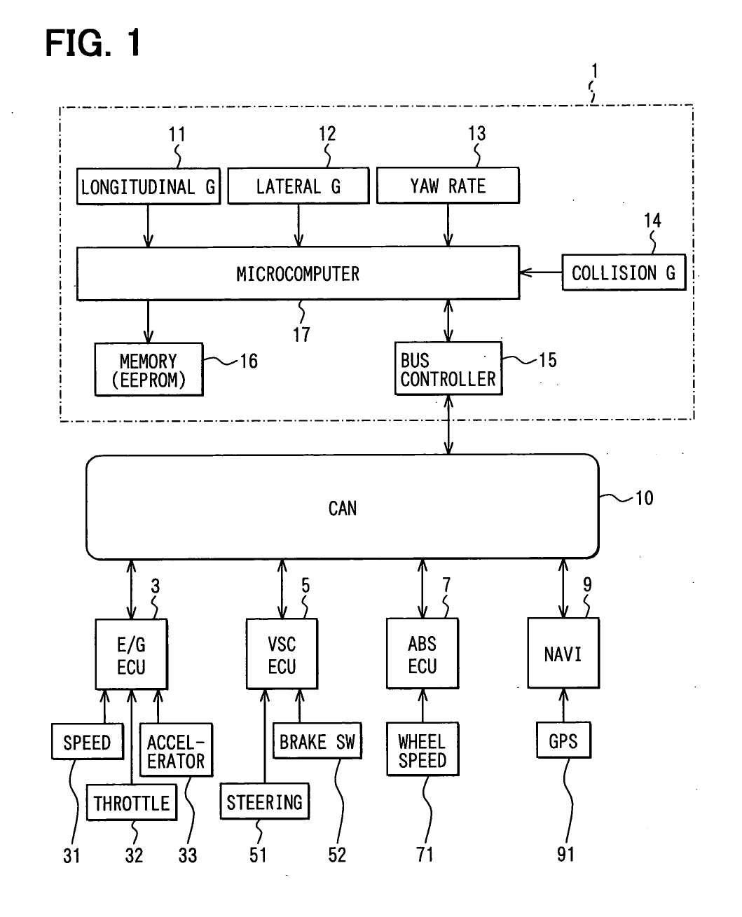

Referring to FIG. 1, an in-vehicle LAN (local area network) 10 is connected to a sensor device 1 of the embodiment. Various electronic control units (ECU) such as an engine ECU 3 that executes the engine control, a VSC ECU 5 that executes the vehicle stability control (VSC) for maintaining traveling stability when the vehicle turns, an ABS ECU 7 that executes the braking slip control in a anti-lock brake system for suppressing the slipping of wheel that may occur when the brake is applied, as well as a navigation unit 9. Here, the VSC ECU 5 and the ABS ECU 7 may be constructed as a unitary structure.

In this embodiment, the data are communicated through the in-vehicle LAN 10 by using a CAN (controller area network) protocol that is generally used in the vehicle-mounted network.

The engine ECU 3 transmits data (vehicle speed, engine controlling state, accelerator operating state) detected by a vehicle speed sensor 31, throttle opening sensor 32 and accelerator pedal opening sensor 33 through the in-vehicle LAN 10, and receives such data as target acceleration and request of fuel cut from a distance-between-vehicle ECU (not shown) that controls the distance to the vehicle in front and the speed of the vehicle through the in-vehicle LAN 10. The internal combustion engine is controlled so as to be operated in a state determined by the received data.

The VSC ECU 5 transmits data (steering operating state, brake applying state, etc.) detected by a steering sensor 51 and a brake switch 52 through the in-vehicle LAN 10, and receives the data such as the yawing rate through the in-vehicle LAN 10. The VSC ECU 5 automatically controls the engine output and the braking force applied to the wheels in order to maintain stability of the vehicle by suppressing the transverse skidding that may occur when the steering wheel is sharply turned to avoid obstacles or when the vehicle has entered into a curve on a slippery road.

The ABS ECU 7 transmits the data (wheel speed) detected by a wheel speed sensor 71 through the in-vehicle LAN 10, and receives the data such as the vehicle speed (vehicle chassis speed) and acceleration (longitudinal G) from the engine ECU 3 and the sensor device 1 through the in-vehicle LAN 10. The ABS ECU 7 controls the braking force (hydraulic braking pressure) so that the slipping ratio of the wheels found based on the vehicle chassis speed and the wheel speed lies within a predetermined range (10 to 20%).

The navigation unit 9 transmits the data (present position of the vehicle, vehicle speed) detected by a GPS unit 91 through the in-vehicle LAN 10, and displays a map in the vicinities of the vehicle, sets the path up to a preset destination and executes the guide control by voice based on the detected data.

Next, the sensor device 1 of the embodiment comprises a longitudinal (back-and-forth) G sensor 11 that detects the acceleration in a longitudinal direction in which the vehicle is traveling, a lateral (left-and-right) G sensor 12 that detects the acceleration in a direction of width of the vehicle, a yaw rate sensor 13 that detects the acceleration about a turning axis of the vehicle, a collision G sensor 14 which generates a collision trigger signal when a large acceleration (e.g., 10 G or more) that may occur upon collision of the vehicle is detected, a bus controller 15 that transmits and receives various data through the in-vehicle LAN 10, a memory 16 which is an EEPROM for storing the data representing the operating states (operating state by the passenger, motion of the vehicle, vehicle state, etc.) of the vehicle, and a one-chip microcomputer 17 constructed chiefly by CPU, ROM and RAM.

The sensor device 1 is arranged near the center of the vehicle so as to obtain favorable results as detected by the sensors 11 to 13 and, particularly, by the yaw rate sensor 13. Specifically, the sensor device 1 is arranged in a space between the shift lever and the hand brake installed in the compartment.

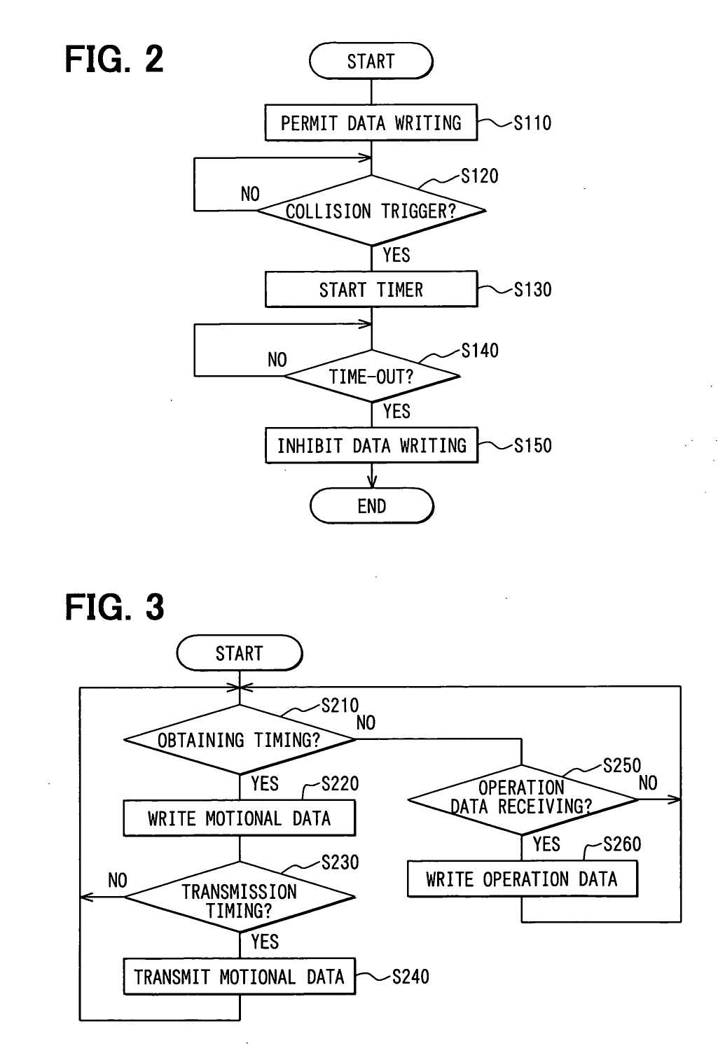

The main processing, and data transmission and reception/memory write processing executed by the microcomputer 17 will now be described with reference to flowcharts illustrated in FIGS. 2 and 3.

These processing start when a power supply to the sensor device 1 is started, and end at a moment when the power supply is ended.

Referring first to FIG. 2, as the main processing starts, the data are permitted to be written into the memory 16 (S110), and it is determined whether a collision trigger signal is output from the collision G sensor 14 (S120). If the collision trigger signal has not been output, the same step is repeated to stand by.

If the collision trigger signal has been output, on the other hand, a timer starts operating to count the time-out after the passage of a preset standby time (S130). It is determined whether the timer has counted the time-out (S140). When the timer has not counted the time-out, the same step is repeated to stand by. When the timer has counted the time-out, on the other hand, writing of data into the memory 16 is inhibited (S15O) and the processing ends.

Next, when the data transmission and reception/memory write processing starts operating in parallel with the main processing, it is determined whether the timing is for obtaining the motional data set for a predetermined period, e.g., 6 ms (S210). When it is the timing for obtaining the motional data, processing is executed for reading the signals output from the longitudinal G sensor 11, lateral G sensor 12 and yaw rate sensor 13, and for writing the motional data of the results of the reading into the memory 16 (S220).

Then, it is determined whether the timing is for transmitting the motional data set for a predetermined period, e.g., 60 ms (S230). When it is not the transmission timing, the routine returns to step S210. When it is the transmission timing, the latest motional data are transmitted through the bus controller 15 (S240), and the routine returns back to step S210.

When it is not the timing for obtaining the motional data, on the other hand, it is determined whether the operation data have been received through the bus controller 15 (S250). Here, the operation data stand for the accelerator operating state, steering operating state and brake applying state that are periodically transmitted, e.g., period of 100 ms from the engine ECU 3 and the VSC ECU 5.

When the operation data have not been received, the routine returns to step S210. When the operation data have been received, on the other hand, processing is executed for writing the received operation data into the memory 16 (S260), and the routine returns to step S210.

Here, at steps S220 and S260, the data are written into the memory 16 for only a period of time from when the writing of data is permitted at step S110 until when the writing of data is inhibited at step S140. The permission/inhibition of writing to the memory 16 may be realized by a software or may be realized by a hardware by controlling the enable signal or the like signal for the memory 16.

The data are written into the memory 16 in order of time series. When the data are written into the whole region, the data are overwritten (updated) starting with the oldest ones. As a whole, the data of an amount of a predetermined holding period (e.g., 20 seconds) are stored in the memory 16. The data stored in the memory 16 are set to be held by the memory 16 for the holding period only.

In case the collision trigger signal is produced, updating of the content of the memory 16 is inhibited after the passage of a standby period (e.g., 10 seconds). Then, the memory 16 holds the data of before and after the production of the collision trigger signal (e.g., 10 seconds each before and after the collision).

As described above in detail, the sensor device 1 of this embodiment transmits the obtained motional data to other ECUs and devices connected to the in-vehicle LAN through the bus controller 15 for every transmission timing to exhibit not only its inherent function but also the function of the so-called drive recorder by recording the motional data obtained for each of the obtaining timings and the operation data received through the bus controller 15 in the memory 16.

By using the sensor device 1, therefore, it is possible to provide the function of the drive recorder at a low cost without installing any new exclusive device.

According to the sensor device 1, further, the motional data which are the most important data for analyzing the cause of collision are detected and are recorded by the same device. Therefore, even in case other devices are destroyed or the signal lines of the in-vehicle LAN are broken due to the collision, the motion of the vehicle at the moment of collision as well as just before and just after the collision can be reliably recorded in the memory 16 provided the sensor device 1 itself is not destroyed.

Besides, the sensor device 1 of this embodiment is installed in the vehicle compartment, and is very less likely to be destroyed by the collision. After the collision, the data recorded in the memory 16 can be recovered highly reliably.

According to the sensor device 1, further, the operation data representing the operating states of the accelerator pedal, steering wheel and brake pedal are obtained through the in-vehicle LAN and are recorded in the memory 16. The operation data need not be obtained in real time as strictly as for the motional data. Therefore, sufficiently helpful data can be obtained even through the in-vehicle LAN.

In this embodiment, the longitudinal G sensor 11, lateral G sensor 12 and yaw rate sensor 13 operate as motion detection means, the collision G sensor 14 operates as collision detection means, the memory 16 operates as storage means, the bus controller 15 and steps S230 to S240 operate as transmission means, steps S220 and S260 operate as updating means, steps S120 to S150 operate as storage holding means, and the bus controller 15 and step S260 operate as receiving means.

It should be noted that the invention is in no way limited to the above embodiment only but can be put into practice in a variety of modes.

In the above embodiment, for example, the EEPROM is used as the memory 16. However, there may be employed any storage device provided it is capable of easily updating the stored content and continues to hold the stored content even after the power supply is interrupted.

In the above embodiment, further, the engine ECU 3 and the VSC ECU 5 periodically transmit, to the sensor device 1, the operation data that are to be stored in the memory 16. However, the sensor device 1 may be so constructed as to monitor the signals that are transmitted and received on the in-vehicle LAN by other ECUs or devices, and to receive necessary data that are transmitted to store them in the memory 16.

In the above embodiment, further, the motional data and the operation data are held by the memory 16 by amounts of the holding period. Here, however, the holding period may be differentiated for the motional data and the operation data. In this case, it can be contrived to lengthen the holding period for the operation data having a long writing period as compared to the holding period for the motional data having a short writing period.

What is claimed is:

1. A sensor device for a vehicle having a communication network and a plurality of electronic control units for vehicle controls, the sensor device comprising:
motion detecting means for detecting motions of a vehicle;
storage means capable of updating stored content and holds the stored content in case a power supply is interrupted;
updating means for updating the content stored in the storage means in a manner that results detected by the motion detecting means are stored in the storage means for a holding period;
collision detecting means for detecting a collision of the vehicle from acceleration exerted on the vehicle;
storage-holding means which, when the collision is detected by the collision detecting means, discontinues operation of the updating means and holds the content stored in the storage means; and
transmission means for transmitting the results detected by the motion detecting means and stored in the storage means,
wherein the storage means, the updating means, the collision detecting means and the storage-holding means are connected to the plurality of electronic control units through the communication network so that the results detected by the motion detecting means are transmitted to the electronic control units through the communication network.

2. A sensor device according to claim 1, wherein the storage-holding means discontinues the operation of the updating means after a passage of a standby period set to be shorter than the holding period.

3. A sensor device according to claim 1, wherein the motion detecting means includes at least one of a longitudinal G sensor for detecting acceleration exerted in a direction in which the vehicle is traveling, a lateral G sensor for detecting acceleration exerted in a direction of width of the vehicle and a yaw rate sensor for detecting acceleration about the turning axis of the vehicle.

4. A sensor device according to claim 1, further comprising:
receiving means for receiving operation data representing operating state of the vehicle through the communication network,
wherein the updating means updates the content stored in the storage means in a manner that the results detected by the motion detecting means as well as the operation data received by the receiving means are stored in the storage means.

5. A sensor device according to claim 4, wherein the receiving means receives at least any one of operating states of an accelerator pedal, a steering wheel and a brake pedal as the operation data.
